(19) United States
(12) Patent Application Publication
(10) Pub. No.: US 2010/0125145 A1
(43) Pub. Date: May 20, 2010

(54) Trans-Esterification Reaction System And Method Thereof

(75) Inventors: Cheng-Ching Yu, Taipei City (TW); Hsiao-Ping Huang, Taipei City (TW); Ming-Jer Lee, Taipei City (TW); Yin-Heng Shen, Taipei City (TW); Jian-Kai Cheng, Changhua County (TW)

Correspondence Address: BEVER HOFFMAN & HARMS, LLP;901 Campisi Way, Suite 370, Campbell, CA, 95008, US

(73) Assignee: National Taiwan University, Taipei (TW)

(21) Appl. No.: 12/465,596

(22) Filed: May 13, 2009

(30) Foreign Application Priority Data
Nov. 14, 2008 (TW) 97144250

(51) Int. Cl. C11C 3/04; B01J 8/04

(52) U.S. Cl. 554/167; 422/189

(57) ABSTRACT

The trans-esterification system for trans-esterifying a triglyceride includes a reaction tank, a separation tank, a first pipe and a second pipe. The reaction tank is inputted with the triglyceride and a monohydric alcohol for undergoing a trans-esterification reaction to produce a mixture. The separation tank is inputted with the mixture for a phase separation to generate an ester phase solution and a glycerol phase solution having a first part and a second part. The first pipe connects the reaction tank and the separation tank, and transports the mixture from the reaction tank to the separation tank. The second pipe connects the reaction tank and the separation tank, and transports the first part of the glycerol phase solution from the separation tank to the reaction tank for undergoing the trans-esterification reaction.

### FIELD OF THE INVENTION

The present invention relates to a trans-esterification reaction system and the method thereof, especially to a trans-esterification reaction system and the method thereof for triglycerides.

### BACKGROUND OF THE INVENTION

After the industrial revolution, plenty of fossil fuels have been being utilized in the human economic activities, which cause the rapid increments of the concentration of the greenhouse gases, e.g. carbon oxide, in the atmosphere. The global temperature increments become more and more apparent, and result in the strong negative impacts on the natural ecosystem, human health, agriculture and water resource, etc. Accordingly, the problems of the climate variation and the global warming become more and more serious.

International Energy Agency (IEA) proposed “Accelerated Technology scenarios (ACTs)” in year 2007 for analyzing the current and developing techniques so as to find out how to reduce the carbon dioxide emission in year 2050 to the current level. Based on the analyzed result of the ACTs, one strategy to reduce the emission of the greenhouse gas is to utilize the biofuel. That is, the biofuel is used to replace the petroleum and natural gas in the industries, and the efficiencies of the energy conversion and utilization should be enhanced.

From the view of the market, the biodiesel can directly replace the fossil diesel and be applied to the diesel engine of the vehicles. The promotion of using biodiesel is easier. In comparisons, the bio-alcohol and leas-free gasoline face the problems of the compatibility, the erosion of the automobile parts and the driving performance. Therefore, the acceptance by the customers becomes the key point for promoting the usage of the biodiesel. The biodiesel is generated from the animal or plant oils or the edible oil through the trans-esterification reaction.

General speaking, the refined plant oil contains the triglycerides higher than 98% with the viscosity about 10 times of the fossil diesel. The burning point and the melting point of the triglycerides are higher than those of the fossil diesel, and the triglycerides may freeze at low temperature. Therefore, directly using the triglyceride as the fuel of diesel engine would result in a lot of problems. The triglyceride mixed with the fossil diesel may have the lowered viscosity and melting point, but still can not reach the desired properties of the fossil diesel. The operation temperature of the thermal cracking processes is in the range of 450 to 850 degree C., and these processes consume a lot of energy, cause the pollution, and thus are seldom utilized in the industries. The trans-esterification reaction of the triglycerides of the animal or plant oils with the short-chain alcohol generates fatty acid alkyl esters, which properties are suitable to be used as the fuel of the diesel engine, and accordingly is the major manufacturing processes of the biodiesel.

Regarding the selection of the alcohols for the trans-esterification reaction, the methanol is chosen by most industrial manufacturers due to its low cost and fast trans-esterification reaction rate. Currently almost all biodiesels are the mixtures containing fatty acid methyl esters.

Please refer to FIG. 1, which is the schematic diagram showing the trans-esterification reaction system of the prior art. At first, the reactants, methanol and triglycerides, are introduced into the reaction tank 10 for the trans-esterification reaction. After then, the product mixture after the reaction is transported from the reaction tank 10 to the separation and purification apparatus 12 for the purification. The fatty acid methyl esters obtained after the separation and purification are the biodiesels, the by-product glycerol can be used for the other applications, and the purified methanol can be transported back to the reaction tank 10 for the trans-esterification reaction.

Since the trans-esterification reaction is a reversible reaction, a lot of excess methanol is often required to be added into the reaction tank 10 to allow the reaction to approach the completion, i.e. the yield rate of fatty acid methyl esters close to 100%. Therefore, the products, i.e. fatty acid methyl esters and glycerol, contain large quantity of methanol, which need to be recycled. Accordingly, the separation and purification apparatus 12 becomes very huge, the quantity needed to be purified is quite large, and thus the large amount of the energy is consumed during the purification procedure. From the above description, it can be seen that new manufacturing system and method are highly expected to solve the problem of the energy consumption, further to reduce the price of the biodiesel, and to promote the competitiveness of the biodiesel compared with the fossil diesel on the price.

In order to solve the above mentioned problem, the new manufacturing system and method with the novel concept are provided in the present invention so that the problem of the energy consumption for the purification processes can be solved, and the production cost of the biodiesel can be significantly reduced. Accordingly, the biodiesel may replace the fossil diesel extensively so as to alleviate the serious problem of the global warming. The present invention is described below.

### SUMMARY OF THE INVENTION

The present invention provides a system and a method for the trans-esterification reaction for the triglycerides. The quantity of the alcohol, e.g. methanol, to be purified can be greatly reduced so as to significantly decrease the energy consumption.

In accordance with one aspect of the present invention, a trans-esterification system for trans-esterifying a triglyceride is provided. The trans-esterification system comprises a reaction tank inputted with the triglyceride and a monohydric alcohol for undergoing a trans-esterification reaction to produce a mixture; a separation tank inputted with the mixture for a phase separation to generate an ester phase solution and a glycerol phase solution having a first and a second parts; a first pipe connecting the reaction tank and the separation tank, and transporting the mixture from the reaction tank to the separation tank; and a second pipe connecting the reaction tank and the separation tank, and transporting the first part of the glycerol phase solution from the separation tank to the reaction tank for undergoing the trans-esterification reaction.

Preferably, the monohydric alcohol comprises at least one selected from a group consisting of a methanol, an ethanol, an n-propyl alcohol and an isopropyl alcohol.

Preferably, the triglyceride and the monohydric alcohol are heated and stirred in the reaction tank so as to promote the trans-esterification reaction.

Preferably, the trans-esterification system further comprises: a purification apparatus inputted with the ester phase solution and the second part of the glycerol solution to produce a purified monohydric alcohol, a purified fatty acid alkyl ester and a purified glycerol; a third pipe connecting the separation tank and the purification apparatus, and transporting the ester phase solution from the separation tank to the purification apparatus; a fourth pipe connecting the separation tank and the purification apparatus, and transporting the second part of the glycerol phase solution from the separation tank to the purification apparatus; and a fifth pipe connecting the purification apparatus and the reaction tank, and transporting the purified monohydric alcohol from the purification apparatus to the reaction tank for undergoing the trans-esterification.

Preferably, the triglyceride is purified from one of a natural plant and an edible oil, and the purified fatty acid alkyl ester is used as a biodiesel.

In accordance with another aspect of the present invention, a trans-esterification reaction method for trans-esterifying a triglyceride is provided. The trans-esterification reaction method comprises (1) continuously providing the triglyceride; (2) continuously providing a monohydric alcohol; (3) continuously mixing the triglyceride and the monohydric alcohol in a first reaction tank for undergoing a trans-esterification reaction to produce a first mixture; (4) continuously transporting the first mixture to a first separation tank for a first phase separation to generate a first ester phase solution and a first glycerol phase solution having a first and second parts; (5) continuously transporting the first part of the first glycerol phase solution from the first separation tank to the first reaction tank to allow the first part of the first glycerol phase solution mixed with the triglyceride and the monohydric alcohol for undergoing the trans-esterification reaction; (6) continuously transporting the first ester phase solution to a second reaction tank for the trans-esterification reaction to produce a second mixture; (7) continuously transporting the second mixture from the second reaction tank to a second separation tank for a second phase separation to generate a second ester phase solution and a second glycerol phase solution having a first and a second parts; and (8) continuously transporting the first part of the second glycerol phase solution from the second separation tank to the second reaction tank to allow the second part of the second glycerol phase solution mixed with the second mixture for undergoing the trans-esterification reaction.

Preferably, the step (3) further comprises a sub-step of respectively adding a catalyst into the first and the second reaction tanks for promoting the trans-esterification reaction.

Preferably, the first glycerol phase solution includes at least a glycerol generated by the trans-esterification reaction and a first unreacted monohydric alcohol; the first ester phase solution includes at least a fatty acid alkyl ester generated by the trans-esterification reaction and a second unreacted monohydric alcohol; and a weight percentage of the first unreacted monohydric alcohol in the first glycerol phase solution is larger than a weight percentage of the second unreacted monohydric alcohol in the first ester phase solution.

Preferably, the trans-esterification reaction method further comprises steps of: (9) continuously transporting the second part of the first glycerol phase solution in the first separation tank and the second part of the second glycerol phase solution in the second separation tank to a first purification apparatus to produce a purified monohydric alcohol and a purified glycerol; (10) continuously transporting the purified monohydric alcohol to the first and the second reaction tanks for undergoing the trans-esterification reaction; (11) continuously transporting the second ester phase solution from the second separation tank to a second purification apparatus to produce a purified fatty acid alkyl ester.

Preferably, the triglyceride is obtained from one of a natural plant and an edible oil, and the purified fatty acid alkyl ester is used as a biodiesel.

Preferably, the monohydric alcohol comprises at least one selected from a group consisting of a methanol, an ethanol, an n-propyl alcohol and an isopropyl alcohol.

In accordance with a further aspect of the present invention, a trans-esterification reaction method for trans-esterifying a triglyceride is provided. The trans-esterification reaction method comprises (1) continuously providing the triglyceride; (2) continuously providing a monohydric alcohol; (3) continuously mixing the triglyceride and the monohydric alcohol in a reaction tank for undergoing the trans-esterification reaction to produce a mixture; (4) continuously transporting the mixture to a separation tank for a phase separation to generate a ester phase solution and a glycerol phase solution having a first and second parts; and (5) continuously transporting the first part of the glycerol phase solution from the separation tank to the reaction tank to allow the first part of the glycerol phase solution mixed with the triglyceride and the monohydric alcohol for undergoing the trans-esterification reaction.

Preferably, the step (3) further comprises a sub-step of adding a catalyst into the reaction tank for promoting the trans-esterification reaction.

Preferably, the catalyst is a sodium hydroxide.

Preferably, the step (3) further comprises a sub-step of heating the triglyceride and the monohydric alcohol for promoting the trans-esterification reaction.

Preferably, the glycerol phase solution includes at least a glycerol generated by the trans-esterification reaction and an unreacted monohydric alcohol, and the ester phase solution includes at least a fatty acid alkyl ester generated by the trans-esterification reaction.

Preferably, the trans-esterification reaction method further comprises steps of: (6) continuously transporting the second part of the glycerol phase solution in the separation tank to a first purification apparatus to produce a purified monohydric alcohol and a purified glycerol; (7) continuously transporting the purified monohydric alcohol to the reaction tank for undergoing the trans-esterification reaction; and (8) continuously transporting the ester phase solution in the separation tank to a second purification apparatus to produce a purified fatty acid alkyl ester.

Preferably, the triglyceride is obtained from one of a natural plant and an edible oil, and the purified fatty acid alkyl ester is used as a biodiesel.

Preferably, the monohydric alcohol comprises at least one selected from a group consisting of a methanol, an ethanol, an n-propyl alcohol and an isopropyl alcohol.

Preferably, a molar ratio of the monohydric alcohol to the triglyceride in the reaction tank is larger than 3:1.

The above objects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is the schematic diagram showing the trans-esterification reaction system of the prior art;

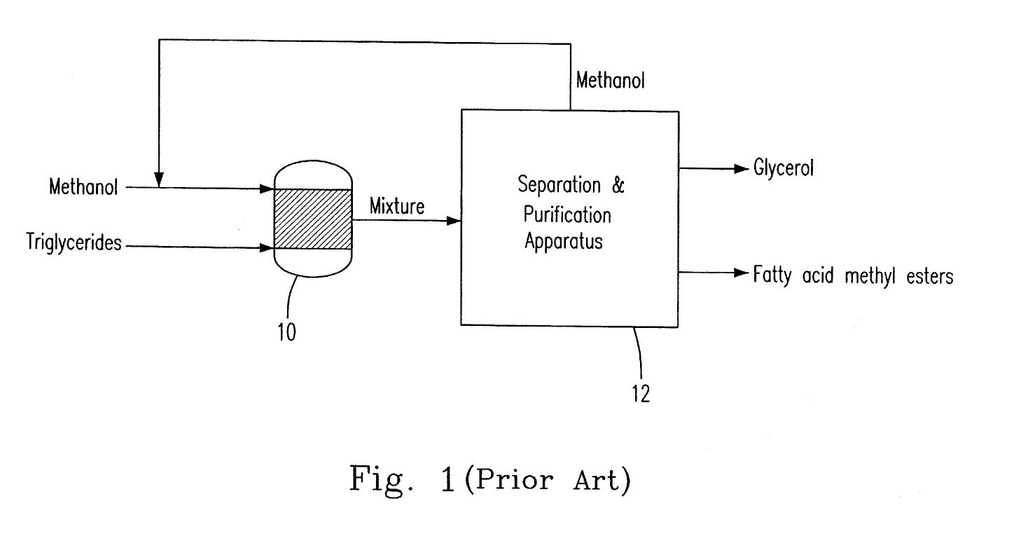

FIG. 2 is the schematic diagram showing the trans-esterification reaction system according to the first embodiment of the present invention;

FIG. 3 is the schematic diagram showing the trans-esterification reaction system according to the second embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

### First Embodiment

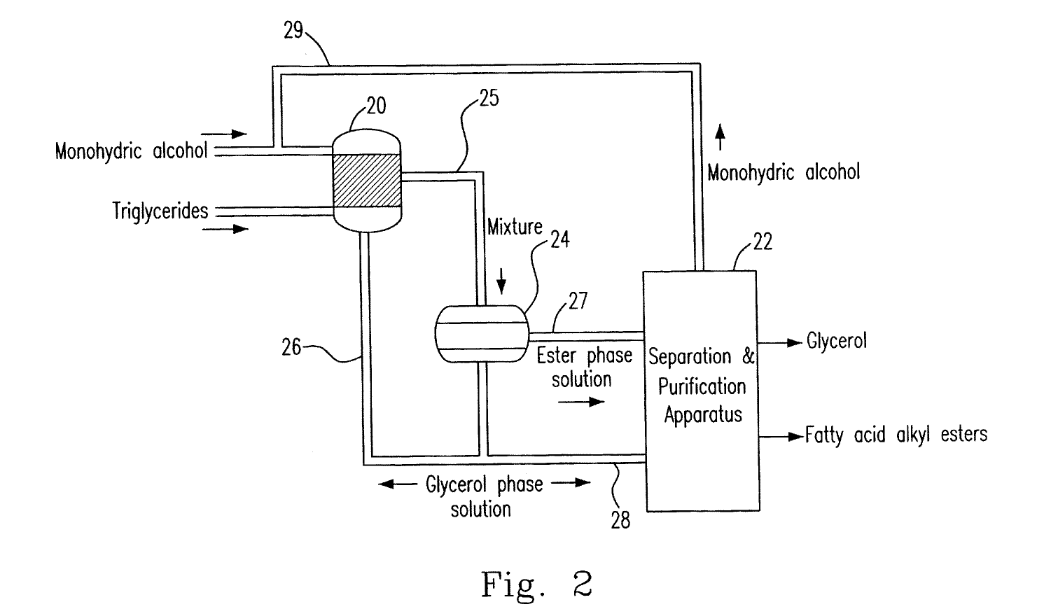

Please refer to FIG. 2, which is the schematic diagram showing the trans-esterification reaction system according to the first embodiment of the present invention. The reactants, monohydric alcohol and triglycerides, are introduced in the reaction tank 20 for the trans-esterification reaction. Then, the reactants inside the reaction tank 20 can be optionally heated up to 65 degree C. at the pressure of one atmosphere, and can be stirred in order to accelerate the reaction. In addition, the homogeneous catalyst, e.g. liquid catalyst, or the heterogeneous catalyst, e.g. solid catalyst, can be optionally added into the reaction tank 20 as well to further accelerate the reaction. In this embodiment, the homogeneous catalyst, NaOH, is used.

In this embodiment, the triglycerides can be extracted directly from the plants, obtained by purifying the edible oil, or obtained by other ways. For instance, plant oils often contain more than 80% or higher triglycerides, which often include several varieties. In this embodiment, the methanol is chosen as the monohydric alcohol. Certainly, ethanol, i.e. alcohol, can be another choice, and the ethanol can be obtained from the plants, i.e. so-called bio-alcohol. Besides, the short chain alcohols, such as n-propanol, isopropanol, etc., can be selected as a monohydric alcohol as well.

Either the continuous or batch production type can be adopted in the trans-esterification reaction system of the present embodiment. General speaking, if the reaction time is not long, the continuous type has the higher production efficiency. Therefore, the continuous type is adopted in the embodiment. The general chemical reaction equation (I) of the trans-esterification reaction in the present invention is listed below

Triglycerides+3 monohydric alcohol→glycerol+3 fatty acid alkyl ester (I)

Since the trans-esterification reaction is a reversible reaction, in order to allow the reaction to approach the completion, the excess amount of the monohydric alcohol, i.e. methanol in this embodiment, needs to be added into the reaction tank 20 so that the almost 100% of triglycerides can be completely reacted to produce the glycerol and fatty acid alkyl ester, i.e. fatty acid methyl ester in this embodiment.

After adding the excess amount of the monohydric alcohol, i.e. methanol, into the reaction tank 20, then the triglycerides and the monohydric alcohol, i.e. methanol, are continuously and steadily added into the reaction tank 20 for the trans-esterification reaction with molar flow ratio of 1:3 according to the molar ratio in the above chemical equation (I).

The mixture after the reaction is transported to the separation tank 24 for the phase separation via the pipe 24. Then, the mixture will be phase-separated to generate the glycerol phase solution on the top and the ester phase solution in the bottom. The large amount of the product, glycerol, and large amount of the unreacted monohydric alcohol, i.e. methanol, exist in the glycerol phase solution; while the product, fatty acid alkyl ester, i.e. fatty acid methyl ester, and the small amount of unreacted monohydric alcohol, i.e. methanol, exist in the ester phase solution.

Then, the partial glycerol phase solution is transported to the reaction tank 20 via the second pipe 26 so that the large amount of the unreacted monohydric alcohol, i.e. methanol, can be mixed with the reactants, triglycerides and monohydric alcohol, and can be continuously involved in the trans-esterification reaction. Besides, another portion of the glycerol phase solution is transported to the separation and purification apparatus 22 via the fourth pipe 28, and the ester phase solution in the separation tank 24 is transported to the separation and purification apparatus 22 via the third pipe 27. After the separation and purification, the fatty acid alkyl ester, i.e. fatty acid methyl ester, is obtained as the biodiesel, the obtained glycerol can be used for the other applications, and the monohydric alcohol, i.e. methanol, can be transported to the reaction tank 20 via the fifth pipe 29 for the trans-esterification reaction.

In this embodiment, since the partial glycerol phase solution is transported back to the reaction tank 20 via the second pipe 26, thus the large amount of the unreacted monohydric alcohol, i.e. methanol, in the glycerol phase solution can be continuously involved in the trans-esterification reaction. That is to say, the separation and purification processes with the large amount of the energy consumption for the large amount of the unreacted monohydric alcohol, i.e. methanol, in the glycerol phase solution in the current technologies is no longer required. The large amount of the unreacted monohydric alcohol in the glycerol phase solution can be directly recycled and can be continuously involved in the trans-esterification reaction in the present embodiment.

In this embodiment, the reaction retention time in the reaction tank 20 takes two hours, the recycling ratio for the glycerol phase solution (i.e. the ratio of the flow rate in the second pipe 26 to the flow rate in the fourth pipe 28) is set to 3:1, and then the ratio of the monohydric alcohol to the triglycerides inputted into the reaction tank 20 equal to 10:1 is required to reach the trans-esterification mole conversion rate of 99%. In contrast, if the unreacted monohydric alcohol is not recycled as in the conventional system, when the reaction retention time in the reaction tank still takes two hours, that is, the recycling ratio for the glycerol phase solution is zero, and then the ratio of the monohydric alcohol to the triglycerides inputted into the reaction tank 20 higher than 20:1 is required to reach the same trans-esterification mole conversion rate of 99%. That is to say, the ratio of the monohydric alcohol to the triglycerides inputted into the reaction tank is significantly reduced from 20:1 to 10:1 by adopting the system of the present embodiment with the recycling of the glycerol phase solution.

Therefore, the trans-esterification reaction system and method of the present embodiment can effectively reduce the quantity of the compounds needed to be separated and purified, can further shrink the scale of the separation and purification apparatus 22, and can greatly decrease the costs of the construction, operation and maintenance for the separation and purification apparatus 22. Accordingly, the energy consumption for the separation and purification processes can be greatly decreased.

### Second Embodiment

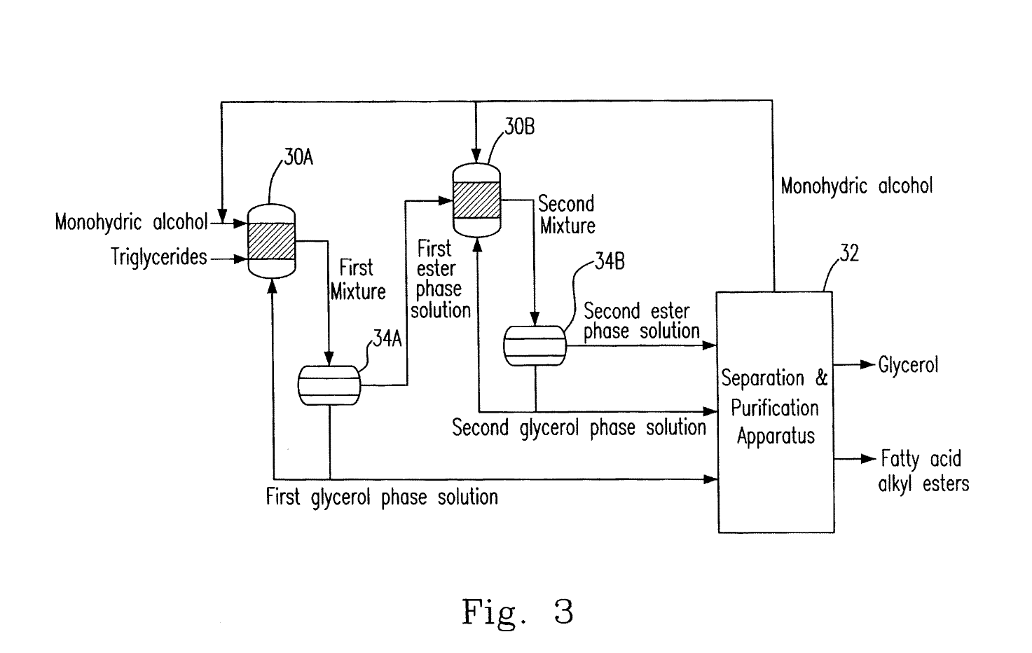

Please refer to FIG. 3, which is the schematic diagram showing the trans-esterification reaction system according to the second embodiment of the present invention. The difference between the present embodiment and the first embodiment is: the single reaction tank and the single separation tank are adopted in the first embodiment; while the dual reaction tanks and the dual separation tanks are designed in the present embodiment. As referring to FIG. 3, at first, the reactants, the monohydric alcohol, i.e. methanol in this embodiment, and triglycerides, are introduced in the first reaction tank 30A for the trans-esterification reaction, where the method of introducing the excess amount of the monohydric alcohol, i.e. methanol, and the molar flow ratio of the two reactants are the same as those in the first embodiment, and would not be repeated in detail here.

Then, the first mixture after the trans-esterification reaction in the first reaction tank 30A is transported to the first separation tank 34A for the phase separation. At this moment, the first glycerol phase solution on the top and the first ester phase solution on the bottom will form.

After then, the partial first glycerol phase solution in the first separation tank 34A is transported back to the first reaction tank 30A so that the large amount of the unreacted monohydric alcohol, i.e. methanol, in the first glycerol phase solution can be continuously involved in the trans-esterification reaction without undergoing the separation and purification processes so as to reduce the energy consumption. In addition, another portion of the first glycerol phase solution is transported to the separation and purification apparatus 32 for the separation and purification. On the other hand, the first ester phase solution in the first separation tank 34A is transported to the second reaction tank 30B for the trans-esterification reaction to generate the second mixture after the reaction.

The second mixture in the second reaction tank 30B is then transported to the second separation tank 34B for the phase separation to form the second glycerol phase solution on the top and the second ester phase solution on the bottom. After then, the partial second glycerol phase solution is transported to back the second reaction tank 30B so that the large amount of the unreacted monohydric alcohol, i.e. methanol, in the second glycerol phase solution can be mixed with the second mixture, and can be continuously involved in the trans-esterification reaction without undergoing the separation and purification processes so as to reduce the energy consumption. Besides, another portion of the second glycerol phase solution is transported to the separation and purification apparatus 32 for the separation and purification. In addition, the second ester phase solution in the second separation tank 34B is transported to the separation and purification apparatus 32 for the separation and purification.

After the separation and purification, the fatty acid alkyl ester, i.e. fatty acid methyl ester in the present embodiment, is obtained as the biodiesel, the obtained glycerol can be used in the other applications, and the monohydric alcohol, i.e. methanol, is transported back to the first reaction tank 30A and the second reaction tank 30B for the trans-esterification reaction.

In this embodiment, the reaction retention time in each of the reaction tanks 30A and 30B takes two hours, the recycling ratio for the first and the second glycerol phase solutions is set to 10:1, and then the ratio of the monohydric alcohol to the triglycerides inputted into the first reaction tank 30A equal to 7:1 is required to reach the trans-esterification mole conversion rate of 99.6%. That is to say, the ratio of the monohydric alcohol to the triglycerides inputted into the reaction tank is tremendously reduced from 20:1 to 7:1 by adopting the system of the present embodiment with the recycling of the first and the second glycerol phase solutions, as compared to the conventional system

In this embodiment, since the partial first glycerol phase solution is transported back the first reaction tank 30A and the partial second glycerol phase solution is transported back to the second reaction tank 30B so that the large amount of the unreacted monohydric alcohol, i.e. methanol, in these glycerin phase solutions can be directly recycled for the trans-esterification reaction without undergoing the separation and purification processes so as to reduce the energy consumption. From the experimental and calculated results, the energy consumption of the separation and purification apparatus 32 in the present embodiment is only 58.3% of that of the conventional system, and the total annual cost for the trans-esterification reaction system in the present embodiment is only 78.6% of that of the conventional system. Therefore, the trans-esterification reaction system and method of the present embodiment can effectively decrease the quantity of the compound needed to be separated and purified, and accordingly further reduce the energy consumption and the total annual cost for the trans-esterification reaction system.

In conclusion, the present invention provides the trans-esterification reaction system and a method thereof, and is able to effectively and economically perform the trans-esterification reaction by recycling the intermediate product, i.e. the glycerol phase solution containing the large amount of the unreacted monohydric alcohol so that the quantity of the compounds needed to be separated and purified can be greatly decreased. Accordingly, the scale of the separation and purification apparatus can be shrunk, the costs of the construction, operation and maintenance for the separation and purification apparatus can be greatly reduced, and the energy consumption for the separation and purification processes is significantly diminished. Consequently, the production cost of the biodiesel can be further reduced, the price competiveness of the biodiesel compared with the fossil diesel can be promoted, and the market share of the biodiesel conforming to the environmental requirements is expected to be raised. Therefore, the present invention can produce the biodiesel with the lower energy consumption than the current technologies, and can make the contributions to alleviate the global warming issue.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A trans-esterification system for trans-esterifying a triglyceride, comprising:
a reaction tank inputted with the triglyceride and a monohydric alcohol for undergoing a trans-esterification reaction to produce a mixture;
a separation tank inputted with the mixture for a phase separation to generate an ester phase solution and a glycerol phase solution having a first and a second parts;
a first pipe connecting the reaction tank and the separation tank, and transporting the mixture from the reaction tank to the separation tank; and
a second pipe connecting the reaction tank and the separation tank, and transporting the first part of the glycerol phase solution from the separation tank to the reaction tank for undergoing the trans-esterification reaction.

2. A system according to claim 1, wherein the monohydric alcohol comprises at least one selected from a group consisting of a methanol, an ethanol, an n-propyl alcohol and an isopropyl alcohol.

3. A system according to claim 1, wherein the triglyceride and the monohydric alcohol are heated and stirred in the reaction tank so as to promote the trans-esterification reaction.

4. A system according to claim 1, further comprising:
a purification apparatus inputted with the ester phase solution and the second part of the glycerol solution to produce a purified monohydric alcohol, a purified fatty acid alkyl ester and a purified glycerol;
a third pipe connecting the separation tank and the purification apparatus, and transporting the ester phase solution from the separation tank to the purification apparatus;
a fourth pipe connecting the separation tank and the purification apparatus, and transporting the second part of the glycerol phase solution from the separation tank to the purification apparatus; and
a fifth pipe connecting the purification apparatus and the reaction tank, and transporting the purified monohydric alcohol from the purification apparatus to the reactor for undergoing the trans-esterification.

5. A system according to claim 4, wherein the triglyceride is purified from one of a natural plant and an edible oil, and the purified fatty acid alkyl ester is used as a biodiesel.

6. A trans-esterification reaction method for trans-esterifying a triglyceride, comprising:
(1) continuously providing the triglyceride;
(2) continuously providing a monohydric alcohol;
(3) continuously mixing the triglyceride and the monohydric alcohol in a first reactor for undergoing a trans-esterification reaction to produce a first mixture;
(4) continuously transporting the first mixture to a first separation tank for a first phase separation to generate a first ester phase solution and a first glycerol phase solution having a first and second parts;
(5) continuously transporting the first part of the first glycerol phase solution from the first separation tank to the first reaction tank to allow the first part of the first glycerol phase solution mixed with the triglyceride and the monohydric alcohol for undergoing the trans-esterification reaction;
(6) continuously transporting the first ester phase solution to a second reaction tank for the trans-esterification reaction to produce a second mixture;
(7) continuously transporting the second mixture from the second reaction tank to a second separation tank for a second phase separation to generate a second ester phase solution and a second glycerol phase solution having a first and a second parts; and
(8) continuously transporting the first part of the second glycerol phase solution from the second separation tank to the second reaction tank to allow the second part of the second glycerol phase solution mixed with the second mixture for undergoing the trans-esterification reaction.

7. A method according to claim 6, wherein the step (3) further comprises a sub-step of respectively adding a catalyst into the first and the second reaction tanks for promoting the trans-esterification reaction.

8. A method according to claim 6, wherein:
the first glycerol phase solution includes at least a glycerol generated by the trans-esterification reaction and a first unreacted monohydric alcohol;
the first ester phase solution includes at least a fatty acid alkyl ester generated by the trans-esterification reaction and a second unreacted monohydric alcohol; and
a weight percentage of the first unreacted monohydric alcohol in the first glycerol phase solution is larger than a weight percentage of the second unreacted monohydric alcohol in the first ester phase solution.

9. A method according to claim 6, further comprising steps of:
(9) continuously transporting the second part of the first glycerol phase solution in the first separation tank and the second part of the second glycerol phase solution in the second separation tank to a first purification apparatus to produce a purified monohydric alcohol and a purified glycerol;
(10) continuously transporting the purified monohydric alcohol to the first and the second reaction tanks for undergoing the trans-esterification reaction;
(11) continuously transporting the second ester phase solution from the second separation tank to a second purification apparatus to produce a purified fatty acid alkyl ester.

10. A method according to claim 9, wherein the triglyceride is obtained from one of a natural plant and an edible oil, and the purified fatty acid alkyl ester is used as a biodiesel.

11. A method according to claim 6, wherein the monohydric alcohol comprises at least one selected from a group consisting of a methanol, an ethanol, an n-propyl alcohol and an isopropyl alcohol.

12. A trans-esterification reaction method for trans-esterifying a triglyceride, comprising:
(1) continuously providing the triglyceride;
(2) continuously providing a monohydric alcohol;
(3) continuously mixing the triglyceride and the monohydric alcohol in a reaction tank for undergoing the trans-esterification reaction to produce a mixture;
(4) continuously transporting the mixture to a separation tank for a phase separation to generate a ester phase solution and a glycerol phase solution having a first and second parts; and
(5) continuously transporting the first part of the glycerol phase solution from the separation tank to the reaction tank to allow the first part of the glycerol phase solution mixed with the triglyceride and the monohydric alcohol for undergoing the trans-esterification reaction.

13. A method according to claim 12, wherein the step (3) further comprises a sub-step of adding a catalyst into the reaction tank for promoting the trans-esterification reaction.

14. A method according to claim 13, wherein the catalyst is a sodium hydroxide.

15. A method according to claim 12, wherein the step (3) further comprises a sub-step of heating the triglyceride and the monohydric alcohol for promoting the trans-esterification reaction.

16. A method according to claim 12, wherein the glycerol phase solution includes at least a glycerol generated by the trans-esterification reaction and an unreacted monohydric alcohol, and the ester phase solution includes at least a fatty acid alkyl ester generated by the trans-esterification reaction.

17. A method according to claim 12, further comprising steps of:
(6) continuously transporting the second part of the glycerol phase solution in the separation tank to a first purification apparatus to produce a purified monohydric alcohol and a purified glycerol;
(7) continuously transporting the purified monohydric alcohol to the reaction tank for undergoing the trans-esterification reaction; and
(8) continuously transporting the ester phase solution in the separation tank to a second purification apparatus to produce a purified fatty acid alkyl ester.

18. A method according to claim 17, wherein the triglyceride is obtained from one of a natural plant and an edible oil, and the purified fatty acid alkyl ester is used as a biodiesel.

19. A method according to claim 12, wherein the monohydric alcohol comprises at least one selected from a group consisting of a methanol, an ethanol, an n-propyl alcohol and an isopropyl alcohol.

20. A method according to claim 12, wherein a molar ratio of the monohydric alcohol to the triglyceride in the reaction tank is larger than 3:1.
